(19) United States
(12) Patent Application Publication
(10) Pub. No.: US 2014/0027203 A1
(43) Pub. Date: Jan. 30, 2014

(54) Ladder Carry Grip

(71) Applicant: Myron Whitcomb, Oregon City, OR (US)

(72) Inventor: Myron Whitcomb, Oregon City, OR (US)

(21) Appl. No.: 13/561,975

(22) Filed: Jul. 30, 2012

(51) Int. Cl. E06C 7/00; A45F 5/00

(52) U.S. Cl. 182/129; 294/145

(57) ABSTRACT

A grip to be used for carrying a ladder increases the contact surface area of the load supported by the user's hand. The grip may include contours on its surface to increase contact area and comfort.

### BACKGROUND

Ladders are often made using thin sheet metal or plastic siderails to decrease weight, though ladders can still be quite heavy. Moving the ladders between locations may require putting the ladder in a horizontal position, gripping the siderails with the hand and lifting the ladder. The siderail edge contacts the hand along an edge line and much of the ladder's weight is supported along that line. This can be very uncomfortable and for people who work with ladders on a regular basis can be a source of fatigue on the job.

In one embodiment a ladder lift system is described comprising a ladder including a rail with a web and flanges and a grip with a longitudinal axis, a top surface and gripping surfaces where the top surface includes a slot parallel with the longitudinal axis configured to engage one flange of the ladder rail. The gripping surfaces may be contoured to conform to at least a portion of a user hand.

In another embodiment a resilient handle with a longitudinal axis for transporting a ladder is described comprising two end surfaces perpendicular to the longitudinal axis and a first surface parallel to the longitudinal axis. The handle may also include a second surface comprising the balance of the handle surface with raised portions and recessed portions that correspond to a hand gripping the handle about the longitudinal axis. A channel parallel to the longitudinal axis may open to the first surface and to the two end surfaces where the channel is configured to mate with one edge of the ladder.

Patents and publications related to ladder grips include US Patent Publications 20080011547, 20020046904, 20020189902 and 20100263189 and U.S. Pat. Nos. 5,511,285, 4,754,858, 5,207,364, 6,189,752 and 5,058,789.

### BRIEF DESCRIPTION OF DRAWINGS

FIG. 1 is a perspective view of a portion of a ladder.

FIG. 2 is a perspective view of a ladder supported by a user's hand.

FIG. 3 is a perspective view of a ladder grip or ladder handle.

FIG. 4 is a perspective view of a ladder and a user hand similar to FIG. 2.

FIG. 5 is a cross section view of a grip.

FIG. 6 is a flow chart of steps that may be used in carrying a ladder using a grip.

### SPECIFICATION

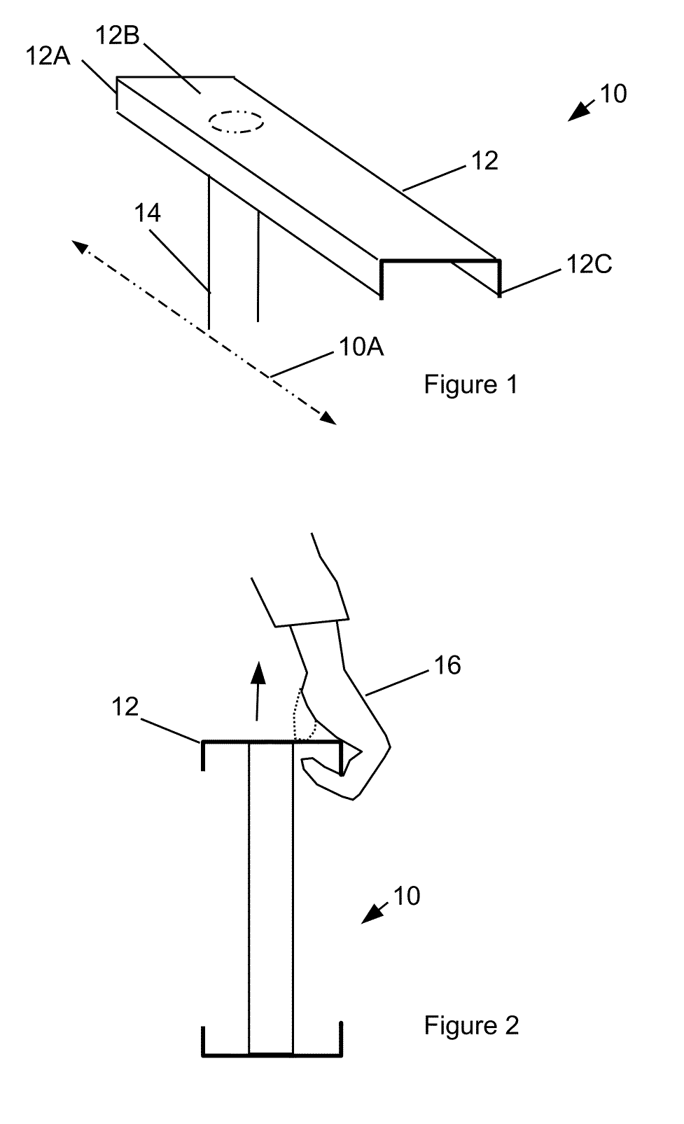

Ladders are well known to those skilled in the arts and is a common tool used by homeowners and tradesmen. FIG. 1 is a perspective view of a portion of a ladder 10. Ladder 10 includes a siderail or rail 12 and a ladder rung 14 connected to rail 12. Rail 12 can have many configurations including a simple beam or an I-beam, but is shown here as a channel or U-beam with two opposing parallel flanges 12A, connecting web 12B and rail edge or edge portion 12C. Edge 12C may run the length of rail 12. There may be two or more edges for each rail. Ladder 10 may have a ladder longitudinal axis 10A parallel to rails 12 as shown by the dotted line and edge 12C may be parallel to axis 10A. Edge 12C of rail 12 may be the boundary or margin of the rail where two substantially parallel faces of the rail material terminate.

Portions of ladder 10 are shown here for clarity. An entire ladder assembly can include a number of rails in different configurations including extension ladders, folding ladders, scaffold ladders and many others. Ladder 10 may encompass any of these configurations.

FIG. 2 is a perspective view of ladder 10 supported by a user's hand 16. The user grips rail 12 which may be configured from a sheet metal and/or plastic. All of the weight of ladder 10 is shown being supported by a line on the palm or fingers of hand 16 where rail edge 12C contacts hand 16. This can cause significant discomfort and fatigue.

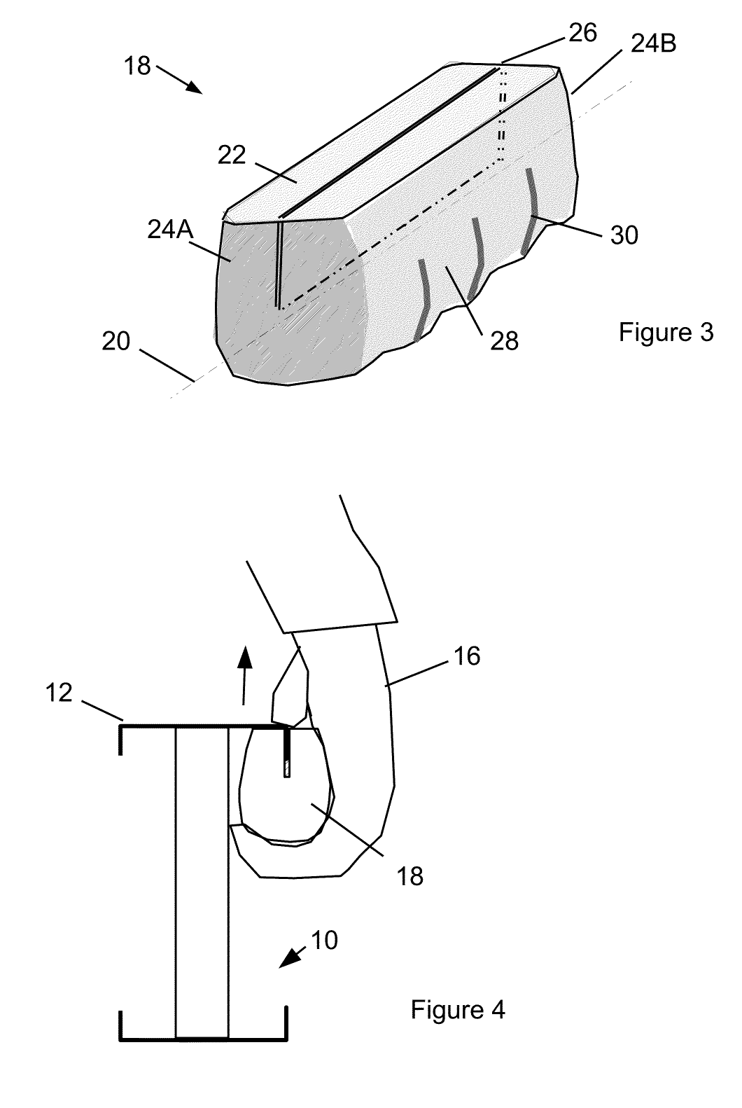

FIG. 3 is a perspective view of a ladder grip or ladder handle 18. Grip 18 may have a grip longitudinal axis 20, a top surface 22 parallel to axis 20, a first end surface 24A and a second end surface 24B which is obscured in this view. End surfaces 24A and 24B are shown substantially perpendicular to axis 20. Ladder grip 18 may include a channel or slot 26 that opens at top surface 22 and end surfaces 24A and 24B. Channel or slot 26 may run substantially parallel to axis 20 and may be configured to accept rail edge 12C. Hidden portions of slot or channel 26 are depicted by dotted lines.

A gripping surface or contoured surface 28 may comprise the balance of the surface of ladder grip 18. Gripping surface 28 may have contours 30 corresponding to user hand 16. Contours 30 of grip 18 may include raised or convex portions and recessed or concave portions of surface 28 forming ridges and valleys. Contours 30 may increase the contact area and comfort of user hand 16 when lifting ladder 10. Alternatively, gripping surface 28 may not be contoured.

Ladder grip 18 may be formed from any workable or mold castable material and may be extruded. Ladder grip 18 may be a resilient plastic material such as a foam or nylon or other polymer. Ladder grip 18 may be homogenous, monolithic and/or uniform. For the purposes of this disclosure monolithic is defined as being made of one piece of a single material.

FIG. 4 is a perspective view of ladder 10 and user hand 16 similar to FIG. 2. Here rail edge 12C is positioned in slot 26 of ladder grip 18. User hand 16 is shown gripping the contoured surface 28 about the longitudinal axis of ladder grip 18. The user has lifted ladder 10 and the weight of ladder 10 is distributed over a significant portion of user hand 16 rather than along a single line of rail edge 12C.

Pushing ladder grip 18 onto rail 12 or, conversely, sliding edge 12C into slot 26, may bias, elastically bend or deflect grip material proximate to slot 26 and as a result ladder grip 18 may be frictionally retained by ladder rail 12. This may allow grip 18 to be removed from ladder 10 once it is moved and reattached to a different ladder for transport. Biasing proximate grip material may result in the material applying a normal force to the surface of rail 12. Alternatively, ladder grip 18 may be permanently fixed, adhered or bonded to ladder 10.

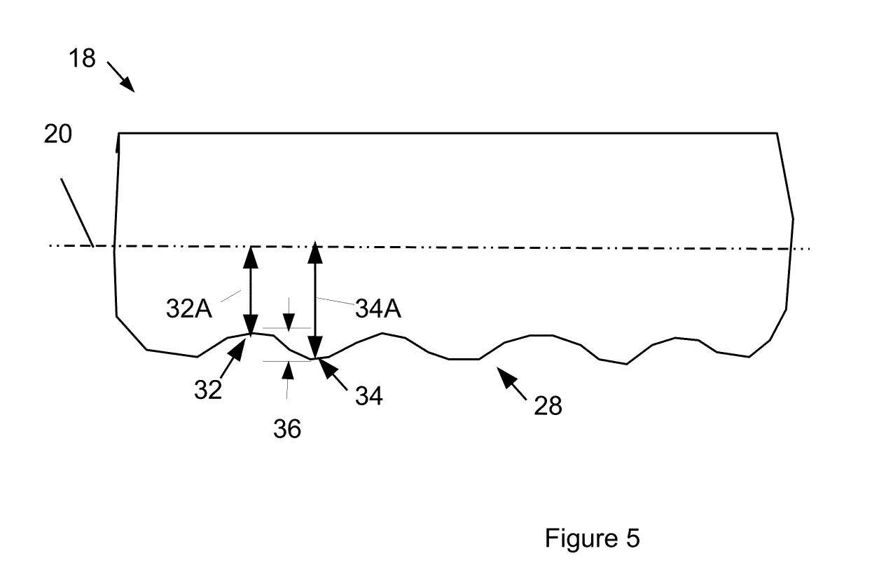

FIG. 5 is a cross section view of grip 18 with longitudinal axis 20. FIG. 5 includes a recessed or concave portion 32 and an adjacent raised or convex portion 34 of contoured surface 28. Lines 32A and 34A indicate the distance from axis 20 to concave portion 32 and convex portion 34 respectively. The difference between distances 32A and 34A of adjacent portions may be considered a contour height 36. In one example the contour height 36 may be a maximum of 0.5 inches and a minimum of 0.0625 inches.

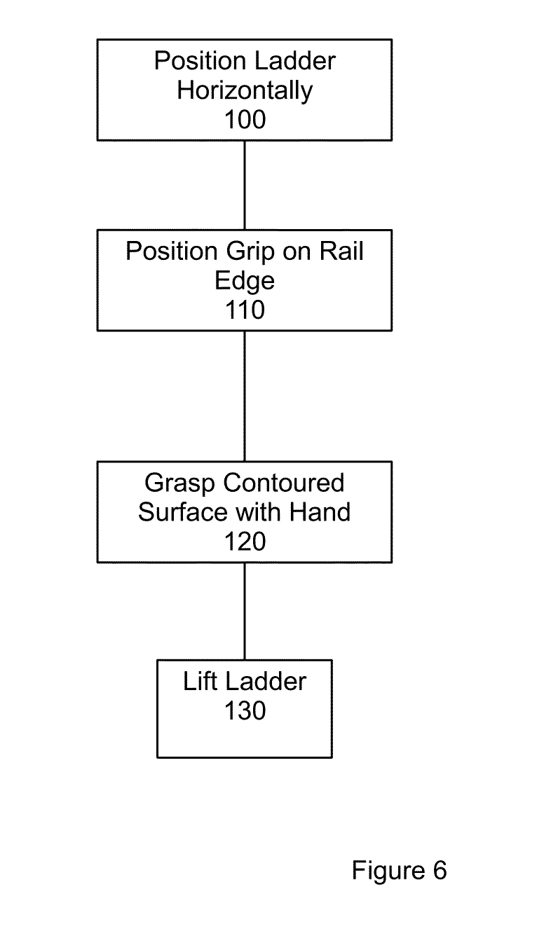

FIG. 6 is a flow chart of steps that may be used in carrying a ladder using grip 18. In step 100 the ladder is put in a horizontal position when referencing longitudinal axis 10A. In step 110 grip 18 is positioned on or engaged by rail edge 12C. In step 120 user hand 16 grasps or engages contoured surface 28 which maximizes the contact surface area. In step 130 user hand 16 exerts or applies a vertical force to raise ladder 10.

The described system and assemblies are examples for the purpose of illustration and are not to be used as limitations. Any suitable configuration or combination of components presented, or equivalents to them that perform a similar function will fall within the scope of this disclosure.

1. A ladder lift system comprising:
a ladder including a rail with a web and flanges; and
a grip with a longitudinal axis, a top surface and a gripping surface, the top surface and gripping surface extending along the longitudinal axis and the gripping surface abuts opposite sides of the top surface;
a slot opening to the top surface and extending toward the longitudinal axis within the gripping surface;
where the slot is configured to accept and contact opposite faces of one flange of the ladder rail along the slot to frictionally retain the grip to the flange.

2. The ladder lift system of claim 1 where the gripping surface curves transversely about the longitudinal axis to abut opposite sides of the top surface.

3. The ladder lift system of claim 2 where the gripping surface is curved about the longitudinal axis so opposite faces of the gripping surface abut the opposite faces of top surface.

4. The ladder lift system of claim 3 where the slot extends from the top surface between the opposite faces of the gripping surface.

5. The ladder lift system of claim 1 where the grip material is monolithic.

6. The ladder lift system of claim 1 where the grip includes opposing ends contiguous with the top and the gripping surface and the grip is confined within the volume defined by the top surface, end surfaces and the gripping surface.

7. The ladder lift system of claim 1 where the grip is bonded to the rail flange.

8. A resilient handle with a longitudinal axis for transporting a ladder with rails and rail edges comprising:
two end surfaces axis;
a first surface substantially parallel to the longitudinal axis;
a second surface curved about the longitudinal axis comprising the balance of the handle surface that abuts opposite sides of the first surface; and
a channel between the curve of the second surface and parallel to the longitudinal axis that opens to the first surface and to the two end surfaces where the channel is configured to contact opposite faces of one edge of the ladder along the channel to frictionally retain the handle to the ladder.

9. The resilient handle of claim 8 where the handle is cast in a mold.

10. The resilient handle of claim 8 where the handle material is a polymer.

11. The resilient handle of claim 8 where the handle is monolithic.

12. The resilient handle of claim 8 where mating with the edge of the ladder deflects the material of the handle and exerts a normal force on the edge of the ladder so the handle is frictionally retained by the edge of the ladder.

13. The resilient handle of claim 8 where the second surface curving about the longitudinal axis creates opposing surfaces that abut the opposite sides of the first surface.

14. A method of carrying a ladder with rails and rungs using a grip comprising:
engaging an edge of the rail in a slot of the grip;
engaging the surface of the grip with a hand with the slot within the surface of the grip and the hand; and
applying a vertical force on the grip to raise the ladder
where the slot contacts opposite faces of one rail of the ladder along the length of the slot to frictionally retain the grip to the flange.

15. The method of claim 14 further comprising positioning the ladder horizontally.

16. The method of claim 14 where engaging the edge of the rail in the slot of the grip causes elastic bending of the grip material and the grip is frictionally retained to the rail.

17. The method of claim 14 where the grip is comprised of a polymer.

18. The method of claim 14 where engaging an edge of the rail in the slot of the grip includes bonding the grip material to the rail material.
